(19) United States
(12) Patent Application Publication
(10) Pub. No.: US 2009/0013396 A1
(43) Pub. Date: Jan. 8, 2009

(54) Secure music, video, audio, and other digital file downloading system and method using encoded plastic magnetic-type information card or smart card chip, or printed terminal receipt, or scratch off panel

(75) Inventor: Joseph V. Rajunas, III, Engewood, NM (US)

Correspondence Address: c/o AFIC Law, Inc., Suite P-136, 3255 Hwy 317, Suwanee, GA, 30024, US

(73) Assignee: Daniel E. Lyford

(21) Appl. No.: 11/523,944

(22) Filed: Sep. 21, 2006

(51) Int. Cl. H04L 9/32; G06F 21/00

(52) U.S. Cl. 726/9

(57) ABSTRACT

A system and method for securely downloading music or other audio or video media in digital format (“Digital Download Media”) from one or more merchants, comprising an encoded plastic magnetic-type information card having an account or access number and other identification and access data encoded, embossed, or printed on the card and a centralized computer system that receives the encoded, embossed, or printed data and allows the cardholder to access and download via internet transmission the Digital Download Media from the centralized computer system. In another embodiment of the invention, a digital electronic chip is encased within the plastic card (a smart card chip) that securely contains the encrypted account or access number and other identification and access data used by the system for the securely downloading the Digital Downloading Media from one or more merchants. Also part of the method, consumers are given access to their respective remaining Digital Download Media values by internet access to the centralized computer system. In a further embodiment of the invention, consumers can, using point-of-sale terminal card-reading devices at multiple merchants, purchase additional units allowing the downloading of additional Digital Downloading Media corresponding to the amount loaded on the plastic card at the merchants' point-of-sale terminals.

### BACKGROUND OF THE INVENTION

This invention describes a system and method for secure music, video, audio, and other digital data file downloading, using a reloadable or non-reloadable encoded plastic magnetic-type information card or smart card chip, or printed terminal receipt, or scratch off panel.

Retail merchants currently sell consumers music, video, and audio content, usually on a CD or DVD, at their retail locations or by mailing such content to purchasing consumers. This invention describes a downloading and payment method using a computer at the Retailer connecting either directly or through the Internet to a purchasing consumer's home computer with a direct file download of the digital data content purchased. The consumer can use a reloadable or non-reloadable encoded plastic magnetic-type information card or smart card chip, or printed terminal receipt, or scratch off panel to pay for the secure downloading of computer files instead of traveling to the Retailer's location or waiting for the mail to arrive.

The consumer purchases a prepaid card, for example, and accesses the Retailer's Internet website to download the Retailer's content (music, video files, etc.) PC to PC instead of having to purchase a CD or DVD. The file transfer is almost immediate because the downloading of content is already prepaid and the file downloaded much quicker than if the consumer had to visit the Retailer's location or wait on mail delivery of a CD or DVD.

Each time a consumer accesses a Retailer's website and downloads digital media content, his prepaid account maintained by the Retailer's computer system, decrements the consumer's digital media account balance to reflect such downloading by the consumer.

The consumer may purchase a non-reloadable file downloading capability such as the purchasing for download of 10 songs or 5 movies, etc. and may be given an access code on his store receipt or a secure scratch off panel at the time of purchase which allows for access to the Retailer's website and downloading digital file content corresponding with the consumer's purchase.

The consumer may alternatively purchase re-loadable media such as an encoded plastic card that allows the consumer to purchase additional downloading capability by adding value to the consumers digital download card.

1. This application describes a method for securely downloading music or other audio or video media in digital format (“Digital Download Media”) from one or more merchants, comprising an encoded plastic magnetic-type information card having an account or access number and other identification and access data encoded, embossed, or printed on the card and a centralized computer system that receives the encoded, embossed, or printed data and that will analyze the information and identify any remaining amount of stored value associated with the account or access number and allows the cardholder to access and download via internet transmission the Digital Download Media from the centralized computer system remotely deducts the decremented amount of Digital Download media downloaded.

2. The method recited in claim 1, wherein, a digital electronic chip is encased within the plastic card (a smart card chip) that securely contains the encrypted account or access number and other identification and access data used by the system for the securely downloading the Digital Downloading Media from one or more merchants.

3. The method recited in claim 1, wherein, the account or access number and other identification and access data used by the system for securely downloading the Digital Downloading Media from one or more merchants is embossed or printed on a secured “scratch off panel” so that the consumer purchases media at a retail merchant and obtains the account number or access data only after scratching off the panel to disclose said data; whereupon the consumer uses the system for securely downloading the Digital Downloading Media from one or more merchants via internet connection.

4. The method recited in claim 1, wherein, the account or access number and other identification and access data (“Access Number”) used by the system for securely downloading the Digital Downloading Media is printed on the consumers receipt so that the consumer purchases a specific quantity of Digital Downloading Media to download, at a retail merchant location, and obtains the Access Number; whereupon the consumer uses the system for securely downloading the Digital Downloading Media from one or more merchants via internet connection.

5. The method recited in claim 1, wherein, consumers are given access to their respective remaining Digital Download Media values by internet access to the centralized computer system.

6. The method recited in claim 1, wherein, consumers can, using point-of-sale terminal card-reading devices at multiple merchants, purchase additional units allowing the downloading of additional Digital Downloading Media corresponding to the amount loaded on the plastic card at the merchants' point-of-sale terminals.
